(19) United States
(12) Patent Application Publication
(10) Pub. No.: US 2004/0252844 A1
(43) Pub. Date: Dec. 16, 2004

(54) Method of interacting with the acoustical modal structure of a room

(76) Inventors: Knud Bank Christensen, Ryomgard (DK); Kim Rishoj Pedersen, Ega (DK)

Correspondence Address: CANTOR COLBURN, LLP, 55 GRIFFIN ROAD SOUTH, BLOOMFIELD, CT, 06002

(21) Appl. No.: 10/477,043

(22) PCT Filed: May 10, 2002
(86) PCT No.: PCT/DK02/00308

(30) Foreign Application Priority Data
Sep. 5, 2001 (DK) PA 2001 00729

(51) Int. Cl. H04R 5/00; H04R 5/02

(52) U.S. Cl. 381/17; 381/310; 381/18

(57) ABSTRACT

The invention relates to a method of interacting with an acoustic modal structure of a room, the method including

determining a transfer function from the input of at least two loudspeakers of an arbitrary loudspeaker setup including the at least two loudspeakers arranged in the room, to at least one reference position,

the set of transfer functions representing influence of the modal structure of the room when propagating audio signals from the input of the at least one loudspeaker to at least one reference position in the room,

providing an audio input signal, and

distributing the input audio signal to the at least two loudspeakers of the loudspeaker setup as individually filtered signals, the signals being filtered on a basis of the at least one set of transfer functions.

### FIELD OF THE INVENTION

The present invention relates to a method of interacting with the acoustical modal structure (AMS) of a room (R) according to claim 1.

### BACKGROUND OF THE INVENTION

The present invention relates to improvement of sound reproduction in a room.

### SUMMARY OF THE INVENTION

The invention relates to a method of interacting with the acoustic modal structure (AMS) of a room (R)

by determining a set of transfer functions (TF) from the inputs of at least two loudspeakers (LS) of an arbitrary loudspeaker setup (LSS) comprising at least two loudspeakers (LS) arranged in a room (R) to at least one reference position (RP),

said set of transfer functions representing the influence of the modal structure of a room (R) when propagating audio signals from the input of said at least two loudspeakers (LS) to at least one reference position (RP) in said room (R),

by providing an audio input signal (AIS),

and distributing said input audio signal to at least two loudspeakers (LS) of said loudspeaker setup (LSS) as individually filtered signals, said signals being filtered on the basis of said determined at least one set of transfer functions (TF).

According to the invention, room compensation may be integrated in a sound rendering system arranged in a specific room having specific frequency responses.

According to the invention, an acoustic modal structure (AMS) may be regarded as a solution to the wave function of a room having certain boundary conditions.

The wave function can be derived from ∇²Φ=1/c²·∂²Φ/∂t²

It should be noted that a room according to the invention is not restricted to a standard rectangular six-wall room but also includes other variants, such as rooms partly defined by side-walls or other types of boundaries and partly by openings such as windows or wider openings to the ambient world.

Again, whenever such a boundary represents a wall having certain absorption characteristics or a regular non-reflecting surface, such as an opening, small or big, the sound propagation space is still regarded as a room.

According to the terms of the invention, the acoustic modal structure of a room may be identified by means of e.g. measurements or mathematical models.

The identified modal structure may be applied to different distribution criteria, such as exciting a standing wave at a certain wavelength conveniently far from a node, i.e. ensuring that the modal structure is excited by a loudspeaker at locations where there is an improved impedance match between the loudspeaker and the air of the room.

According to the invention, the input signals distributed to the different loudspeakers of the loudspeaker setup should be individually filtered signals.

Evidently, under certain conditions, individual filtering may imply that the signals fed to a certain loudspeaker are filtered by an all-pass filter, i.e. without necessarily applying filtering means at all. Still, the input signals distributed to the individual loudspeakers should all be established with a view as to how the other speakers contribute to the interaction with the modal structure.

The interaction with the modal structure of the room is then established as a combination of acoustic low-frequency signals provided by loudspeakers located at different locations in the room.

It should be noted that the desire to establish interaction with the modal structure requires very careful management of “what is distributed to which loudspeaker”.

According to the invention, the input signals distributed to the individual loudspeakers should all be established with a view as to how the other loudspeakers contribute to the interaction with the modal structure.

Evidently, under certain conditions and filtering criteria, a signal may be supplied to one loudspeaker only. Still, it should be emphasized that such a situation still reflects a situation in which the set of pre-established transfer functions points out that the modal structure may be activated or deactivated by means of one loudspeaker only. Still, it should be noted that such situation generally implies that the acoustic signals provided by said individually filtered signals interact in combination with the modal structure of the room.

In other words, according to the invention, the modal structure of a room is activated by distributing individually filtered signals to certain loudspeakers, thereby activating the room by combining different contributions from different loudspeakers into one combined activation of the room.

Evidently, such feature may be applied in the low-frequency spectrum insofar the human ear is unable to perceive the “distorted” directionality.

According to the invention, a given loudspeaker setup may be applied with the purpose of activating the modal structure of a room in an optimal way in the sense that the invention basically offers the possibility of applying even bad loudspeaker setups.

Evidently, the chance of success increases with the number of loudspeakers in the loudspeaker setup.

It should be noted that according to a preferred embodiment of the invention, the determined transfer function implies a transfer function between an electrical input signal to a loudspeaker and an acoustic signal originating from the same loudspeaker and determined at the at least one reference position in the room.

Obviously, the determination of such signal may be made in several different ways by measurements, theoretical calculations, establishment of cascaded models, partly established by measurements and by theoretical models, etc.

When said individually filtered signals comprise low-frequency components below 500 HZ, preferably below 350 Hz, a further advantageous embodiment of the invention has been obtained.

According to the invention, a particularly advantageous effect may be obtained in the low-frequency band.

According to further embodiments of the invention, low-frequency components may be applied advantageously below 315 Hz.

When said individually filtered signals comprise low-frequency components below 250, preferably 150 Hz, a further advantageous embodiment of the invention has been obtained.

According to the invention, a particularly advantageous effect may be obtained in the low-frequency band below approximately 150 to 200 Hz.

In this low-frequency spectrum, modal structures of individual modes of individual frequencies may be controlled or manipulated individually (contrary to modes of high frequencies). This feature is particularly important when dealing with signals comprising audio information to be perceived by the human ear insofar the distribution of a signal originating from one channel of a multi-channel signal may be added to another channel without disturbing the overall perception when listening to a multi-channel signal propagated in a room.

Hence, according to the preferred embodiment of the invention, the relevant signals derived from the audio input signal may be distributed primarily with a view as to how the propagated sound interacts with the propagation media—typically air—of a room, even if the complete input audio signal comprises directional information.

It should be noted that the frequency spectrum of interest facilitates high-resolution filters with respect to frequency.

When said transfer function (TF) is established on the basis a measurement of sound propagation from the individual loudspeakers (LS), a further advantageous embodiment of the invention has been obtained.

When said transfer function (TF) is established on the basis a theoretical sound propagation model of the sound propagation from the individual loudspeakers (LS), a further advantageous embodiment of the invention has been obtained.

According to the invention, empirical or theoretically obtained models may be applied when dealing with a well-defined room.

When said loudspeaker setup comprises at least five loudspeakers, a further advantageous embodiment of the invention has been obtained.

According to the invention, the interaction with modal structures of a room may be applied by means of almost any loudspeaker setup.

Hence, a low-frequency signal may be distributed to different loudspeakers of a multi-channel loudspeaker setup, e.g. a standard five-channel speaker setup.

When at least one of said loudspeakers of said loudspeaker setup comprises a subwoofer, a further advantageous embodiment of the invention has been obtained.

According to the invention, a further advantageous effect may be obtained by applying more than one subwoofer, e.g. two or three, since subwoofers are usually optimized for low-frequency rendering by nature.

Evidently, the number of subwoofers may e.g. be increased according to a further embodiment of the invention.

When said modification at given frequencies involves the loudspeakers (LS) of the loudspeaker setup situated in or relatively close to the pressure maxima of said modal structure (AMS), a further advantageous embodiment of the invention has been obtained.

When distributing said input audio signal to at least two loudspeakers (LS) of said loudspeaker setup (LSS) as individually filtered signals, said signals being filtered on the basis of said determined at least one set of transfer functions (TF),

whereby said individual filtering of the input signal fed to a specific loudspeaker (LS) is performed with the purpose of obtaining a flat magnitude response at said reference position (RP), a further advantageous embodiment of the invention has been obtained.

According to the invention, a flat magnitude response may also determine a perceptually flat magnitude response.

When distributing said input audio signal to at least two loudspeakers (LS) of said loudspeaker setup (LSS) as individually filtered signals, said signals being filtered on the basis of said determined at least one set of transfer functions (TF),

whereby said individual filtering of the input signal fed to a specific loudspeaker (LS) is performed with the purpose of obtaining improved efficiency, a further advantageous embodiment of the invention has been obtained.

According to the invention, improved efficiency may be regarded as obtaining a desired sound impression at least one reference position with a minimum of electrical power.

When distributing said input audio signal to at least two loudspeakers (LS) of said loudspeaker setup (LSS) as individually filtered signals, said signals being filtered on the basis of said determined at least one set of transfer functions (TF),

whereby said individual filtering of the input signal fed to a specific loudspeaker (LS) is performed with the purpose of obtaining spatial properties related to interaural differences at the listener's ears when in listening position characterized by reduced interaural cross-correlation, such as “Externalization”, “Spaciousness” or “Envelopment”, a further advantageous embodiment of the invention has been obtained.

Evidently, when dealing with Inter Aural Cross Correlation, at least two reference positions should be applied with the purpose of emulating a stereo perception at the listening position.

When said modification at given frequencies comprises activation or attenuation of the loudspeakers (LS) of the loudspeaker setup situated in or relatively close to a pressure minima, a further advantageous embodiment of the invention has been obtained, thereby saving power by feeding little or no energy to loudspeakers having little or no influence on the sound field propagation in the room.

When said individually filtered signals are established by means of long FIR-filters at a low sampling frequency, a further advantageous embodiment of the invention has been obtained.

According to the invention, a low sampling frequency may e.g. be approximately 1 kHz, thereby facilitating a high-resolution filtering bandwidth corresponding to relatively long impulse responses due to the fact that the spectrum of interest is conveniently below 150-300 Hz.

It should be noted that narrow filters are required in order to obtain the desired mode interaction if individual modes are addressed.

According to the invention, a low sampling frequency may typically be below 2 kHz.

When distributing said input audio signal to at least two loudspeakers (LS) of said loudspeaker setup (LSS) as individually filtered signals, said signals being filtered on the basis of said determined at least one set of transfer functions (TF),

whereby said individual filtering of the input signal fed to a specific loudspeaker (LS) is performed with the purpose of absorbing sound at certain frequencies, a further advantageous embodiment of the invention has been obtained.

According to a further embodiment of the invention, loudspeakers may be applied to absorb sound at certain frequencies at certain interaction points of the modal structure of the room.

Thereby, modal peaks of the room characteristics may be damped as if the sound is actually damped by the wall of the room.

When distributing said input audio signal to at least two loudspeakers (LS) of said loudspeaker setup (LSS) as individually filtered signals, said signals being filtered on the basis of said determined at least one set of transfer functions (TF),

whereby said individual filtering of the input signal fed to a specific loudspeaker (LS) is performed with the purpose of adding desired room effects, a further advantageous embodiment of the invention has been obtained.

According to the invention, sound propagated in a room having certain boundary conditions may interact with loudspeakers, thereby modifying the propagated sound in the room as if the sound was a result of other boundary conditions.

Hence, according to the invention, a room-adaptive reverberation method at low frequencies has been obtained.

When said individually filtered signals distributed to said at least two loudspeakers (LS) contribute to the interaction with said modal structure, a further advantageous embodiment of the invention has been obtained.

Moreover, the invention relates to a rendering system comprising at least two loudspeakers (LS) arranged arbitrarily in a room (R) according to claim 17,

said system comprising individual filtering means (HRDF) adapted to distributing an input audio signal (AIS) to said at least two loudspeakers (LS1, LS2),

said filtering means (HRDF) distributing the low-frequency components of said input audio signal (AIS) to said at least two loudspeakers (LS1, LS2) according to at least two predetermined transfer functions (TF),

said at least two predetermined transfer function (TF) being established on the basis of the relative positioning between the modal structure of said room and said at least two loudspeakers (LS1, LS2).

According to the invention, low-frequency components comprise frequency components below 300 Hz, preferably below 150 Hz.

When said at least two loudspeakers interact with the modal structure of a room according to any of claims 1 to 16, a further advantageous embodiment of the invention has been obtained.

Moreover, the invention relates a system according to claim 19 for propagating acoustic signals in a room (R) according to the method of claim 1-16, said system comprising

at least two loudspeakers (LS1, LS2)

filtering means (HRDF) for distributing components, preferably low-frequency components, of said input audio signal (AIS) to said at least two loudspeakers (LS1, LS2) according to at least one set of predetermined transfer functions (TF).

Moreover, the invention relates to a loudspeaker controller according to claim 20 comprising

at least one input means

at least one output means

said output means being coupled to at least two loudspeakers, preferably subwoofers,

means for distributing at least one input signal obtained by said input means to at least two loudspeakers of a loudspeaker setup on the basis of at least one set of predetermined transfer functions,

said at least one set of transfer functions representing the influence of the modal structure of a room (R) when propagating audio signals from the input of said at least two loudspeakers (LS) to at least one reference position (RP) in a room (R).

According to the invention, the loudspeaker controller should preferably deal with a low-frequency signal below 500 Hz, preferably below 315 Hz, and even more advantageously below 150 Hz.

Moreover, the invention relates to a subwoofer controller according to claim 21 comprising

at least one input means

at least one output means

said output means being coupled to at least two subwoofers,

means for distributing at least one input signal obtained by said input means to at least two subwoofers of a loudspeaker setup on the basis of at least one set of predetermined transfer functions,

said at least one set of transfer functions representing the influence of the modal structure of a room (R) when propagating audio signals from the input of said at least two subwoofers (LS) to at least one reference position (RP) in a room (R).

According to the above-stated embodiments of the invention, a loudspeaker setup with e.g. two or more subwoofers may be added to an existing multi-channel system. The controller may typically receive e.g. a traditional center channel signal of a multi-channel setup and this signal may be distributed to the loudspeakers applied in the added loudspeaker/subwoofer setup.

The loudspeaker/subwoofer controller may so to speak be applied to improve the low-frequency performance in a given room.

It should be noted that the invention generally accepts a given loudspeaker setup and therefore improves the loudspeaker setup, even if the loudspeakers are not optimally located in the relevant room. Hence, according to the invention, a loudspeaker poorly located for propagating a certain frequency in a room due to the modal structure may simply be supplemented by another loudspeaker located in a more favorable position with respect to the relevant mode.

According to the invention, the subwoofer controller should preferably deal with a low-frequency signal below 500 Hz, preferably below 315 Hz, and even more advantageously below 150 Hz.

One particularly interesting embodiment of the invention is an intelligent network of active subwoofers according to claims 19, 20 and 21 with built-in calibration microphones and measurement, computation and filtering means (may be in a separate controller box). With these subwoofers distributed in the corners of the room, measurement of the transfer functions from each subwoofer to the microphones placed on all other subwoofers may be sufficient to characterize the resonance frequencies, phases and damping of the modes, since all modes have a pressure maxima in the room corners. Subsequently, the subwoofers in the network may distribute the roles of sound emitters and active sound absorbers among them, effecively damping all modes in the low-frequency range and thus yielding a smooth uniform bass reproduction throughout the room without any need to involve the user in any calibration activities more complicated than that of pressing a button.

When said individually filtered signals comprise audio signals which comprise substantially unidirectional audio signal components when rendered in said arbitrary loudspeakers setup, the audio signals intended for rendering in the room may be distributed primarily with respect the resulting modal structure itself and with less or no respect to the directional information comprised by the audio input signal.

In other words, a part of the spectrum of the audio input signal may be rendered arbitrarily in at least two loudspeakers of the loudspeaker setup without distorting or disturbing the rendering method with respect to directivity of the signal components, and be distributed to the part of the spectrum, filtered or non-filtered—to one or more of the selected loudspeakers when focusing solely or primarily on efficiency, i.e. in praxis: the effect of the modal structure.

The rendering system may comprise a number of spectrum “slicing” filters which may be adapted to propagating specific, selected (preferably low frequency) modes of the signal to be rendered when associated with specific loudspeakers.

When said distribution of said individually filtered signals is substantially independent of the directional information of the individually filtered signals, a further advantageous embodiment of the invention has been obtained.

One of several features of the invention is that the human ear is typically unable to grasp the directional properties of the signal (i.e. direction and location of sound source) at low frequencies.

When at least a part of said individually filtered signals is distributed to at least one channel of said rendering system intended for rendering of directional audio signals, a further advantageous embodiment of the invention has been obtained.

When said reference position (RP) comprises an arbitrarily chosen position in the room (R), a further advantageous embodiment of the invention has been obtained.

When said individually filtered signals are established on the basis of at least one subwoofer channel of a sound rendering system, a further advantageous embodiment of the invention has been obtained.

When said individually filtered signals are distributed to said loudspeakers of said loudspeaker setup on the basis of the frequency of said filtered signals, a further advantageous embodiment of the invention has been obtained.

When said method comprises the steps of

evaluating the efficiency of the rendering of at least one part of the spectrum of an input audio signal (AIS),

rendering said at least a part of the spectrum of an audio signal (AIS) in at least one of said loudspeakers (LS) on the basis of the evaluated efficiency, a further advantageous embodiment of the invention has been obtained.

According to a preferred embodiment of the invention, the evaluated efficiency may be established on the basis of both experimental works and theoretical estimates.

The evaluation may e.g. result in specific transfers functions being related to each or at least two loudspeakers of the loudspeaker setup determining the resulting transfer function from the individual sound emitter to a given position or given positions in the room.

When said at least one of said loudspeakers chosen for the rendering of a at least one part of the spectrum of an input audio signal (AIS) comprises a loudspeaker (LS), which has a better efficiency than at least one other loudspeaker (LS) of the same loudspeaker setup (LSS) when rendering the signal in the at least one room (R), a further advantageous embodiment of the invention has been obtained.

When said at least a part of the spectrum of an input signal comprises low frequency signals, a further advantageous embodiment of the invention has been obtained.

Thus, according to a preferred embodiment of the invention, the loudspeakers for reproduction of the audio signals at low frequencies should preferably be chosen independent of the overall desired directionality.

Basically, according to the invention a compromise is made between optimizing the efficiency when propagating sound in a room and maintaining complete and true directional information in the complete, rendered audio signal.

Thus, the directionality of the low frequency components may advantageously be more or less disregarded. Instead, the rendering of the relevant low frequency components is performed by means the loudspeaker(s) best suited for efficient propagation of the components in the specific room.

When said low frequency signal comprises a signal low-frequency components below 500 Hz, preferably below 350 Hz, more preferably below 250 Hz and even more preferably below 150 Hz, a further advantageous embodiment of the invention has been obtained.

When said rendering is established on the basis of at least two filter setups, and said at least two filter setups are adapted to distributing said input signals (AIS) to at least two different loudspeakers (LS), said at least two filter setups being established with the purpose of distributing selected frequency bands of said input signals (AIS) to selected loudspeakers, a further advantageous embodiment of the invention has been obtained.

When said at least two frequency bands comprise at least two different modes of the modal structure of said room (R), a further advantageous embodiment of the invention has been obtained.

When said loudspeaker setup comprises a multi-loudspeaker setup of at least five loudspeakers (LS), a further advantageous embodiment of the invention has been obtained.

When said rendering system comprises at least two loudspeakers (LS) arranged arbitrarily in a room (R),

said system comprising individual filtering means (HRDF) adapted to distributing an input audio signal (AIS) to said at least two loudspeakers (LS1, LS2),

said filtering means (HRDF) distributing the low-frequency components of said input audio signal (AIS) to said at least two loudspeakers (LS1, LS2) according to at least two predetermined transfer functions (TF),

said at least two predetermined transfer functions (TF) being established on the basis of the relative positioning of the modal structure of said room and said at least two loudspeakers (LS1, LS2), a further advantageous embodiment of the invention has been obtained.

When said loudspeaker controller comprises

at least one input means

at least one output means

said output means being coupled to at least two loudspeakers, preferably subwoofers,

means for distributing at least one input signal obtained by said input means to at least two loudspeakers of a loudspeaker setup on the basis of at least one set of predetermined transfer functions,

said at least one set of a transfer functions representing the influence of the modal structure of a room (R) when propagating audio signals from the input of said at least two loudspeakers (LS) to at least one reference position (RP) in a room (R), a further advantageous embodiment of the invention has been obtained.

When a subwoofer controller comprises

at least one input means

at least one output means

said output means being coupled to at least two subwoofers,

means for distributing at least one input signal obtained by said input means to at least two subwoofers of a loudspeaker setup on the basis of at least one set of predetermined transfer functions,

said at least one set of transfer functions representing the influence of the modal structure of a room (R) when propagating audio signals from the input of said at least two subwoofers (LS) to at least one reference position (RP) in a room (R), a further advantageous embodiment of the invention has been obtained.

It should moreover be noted that the rendering of a low-frequency spectrum is very sensitive to room properties, i.e. the modal structure, in the sense that low frequency rendering requires a significant high power drive compared to high frequency components. Therefore, “wrong” positioning of a loudspeaker, e.g. a subwoofer with respect to certain frequency components may in a relative simple and efficient manner be compensated for by applying a loudspeaker which is more suitable for rendering the relevant frequency/frequencies—i.e. modes in the relevant room.

It should moreover be noted that the term room should be understood very broadly as the location(s) in which the relevant rendering system renders the audio signals.

### THE FIGURES

The invention will now be described in detail with reference to the drawings, in which

FIGS. 1a, 1b, 1c and 1d illustrate examples of modal structures of a room,

FIG. 2a illustrates some of the characteristics of the sound in the room of FIG. 1a,

FIG. 2b shows the same two graphs as FIG. 2a, but for a room with better damping,

FIG. 2c illustrates some of the characteristics of the sound in the room of FIG. 1b,

FIG. 3 shows a speaker set-up according to the ITU 775 multi-channel standard,

FIGS. 4a and 4b illustrate how an embodiment of the invention interacts with the modal structures of a room for two different frequencies,

FIG. 5 illustrates how signals from a multi-channel amplifier and surround sound decoder are traditionally fed to the 6 loudspeakers,

FIG. 6 shows a first preferred embodiment of the invention to be used with the multi-channel speaker set-up,

FIG. 7 shows a second preferred embodiment of the invention complying with the standard stereo speaker set-up,

FIG. 8 shows another preferred embodiment of the invention to be used with a stereo subwoofer multi-channel set-up,

FIG. 9 illustrates an example of a very simple algorithm to be used for determining the high-resolution digital filters to be implemented,

FIG. 10 illustrates how one input audio signal is distributed to two loudspeakers according to a preferred of the invention.

### DETAILED DESCRIPTION

It is the object of this invention to optimize reproduction of sound (music or speach), especially for the low-frequency band. The invention mainly addresses the low-frequency band, but all frequency bands fall within the scope of the invention. In the following, frequencies within the range of 0-350 Hz, preferably 150 Hz, are referred to whenever the term “low-frequency” is used.

In any enclosed space, the sound field consists of standing waves, also called modes. In the following, both terms will be used. Each mode represents one resonance frequency. The average spacing in frequency of the modal resonance frequencies is inversely proportional to the room volume, and the bandwidth of the resonance is proportional to the damping or absorption in the room. In practice, this means that the bigger the room, the greater the number of possible modes, which, in turn, means more frequencies to choose from. Also, the more dampening of the walls, the broader the frequency band represented by each mode.

Prior art states that for a rectangular room, possible modes are well-documented and easy to calculate. Each mode is identified by a set of three numbers e.g. (1 2 0). This example means that the standing wave in the x-direction has a length of 1 half wavelength of the modal resonance frequency, the standing wave in the y-direction has a length of 2 half wavelengths and that the standing wave in the z-direction has a length of zero half wavelengths (that is: there is no standing wave in the z-direction). The resonance frequency fₙ within a simplified undamped room with the dimensions lₓ×l_{y}×l_{z} for a mode (nₓ n_{y} n_{z}), where nₓ, n_{y}, n_{z} are numbers greater than or equal to zero, is given by the following equation, where c is the speed of sound, typically 343 m/s:

$${f}_{n} = \frac{c}{2} \sqrt{{( \frac{{n}_{x}}{{l}_{x}} )}^{2} + {( \frac{{n}_{y}}{{l}_{y}} )}^{2} + {( \frac{{n}_{z}}{{l}_{z}} )}^{2}}$$

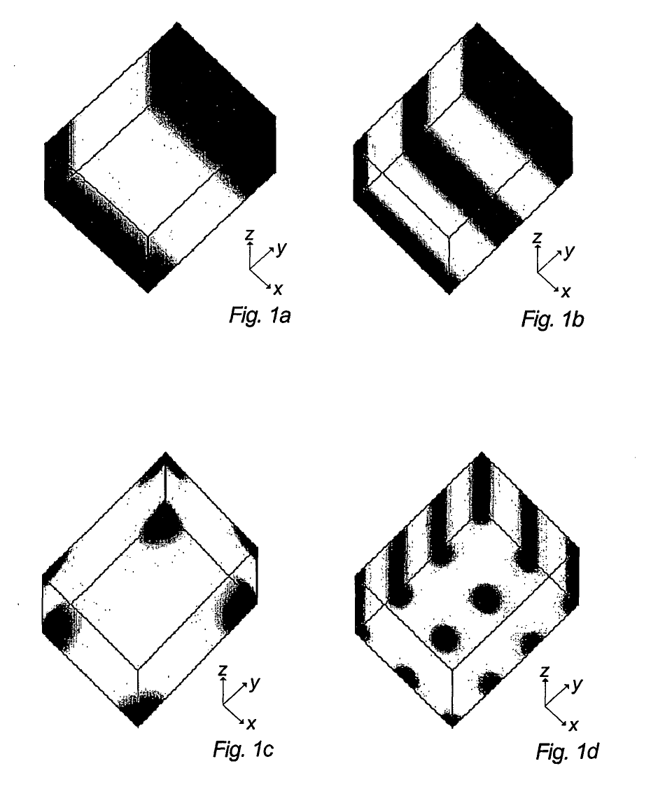

FIGS. 1a, 1b, 1c and 1d, illustrate how some modes are built inside a room for different frequencies. The room shown in the examples has the dimensions 4×5.2×2.4 meters. As the wavelength of sound waves is inversely proportional to the frequency, the wavelengths of low-frequency tones are long compared to high-frequency tones. A result hereof is that in the bass tone range, the half wavelength which is the shortest standing wave, is several meters. This means that when walking through a room, it is possible to hear where there is high sound pressure, and where there is little sound pressure. This is illustrated in FIG. 1a which shows a room with the dimensions 4×5.2×2.4 meters, and a mode (0 1 0) which is a one-dimensional standing wave. From the above equation, the resonance frequency is calculated to 33 Hz. The dark parts represent locations inside the room with high sound pressure and low velocity. The light parts represent locations inside the room with low sound pressure and high velocity. When standing in one of the ends of the room, the sound pressure is bigger than when standing in the middle of the room.

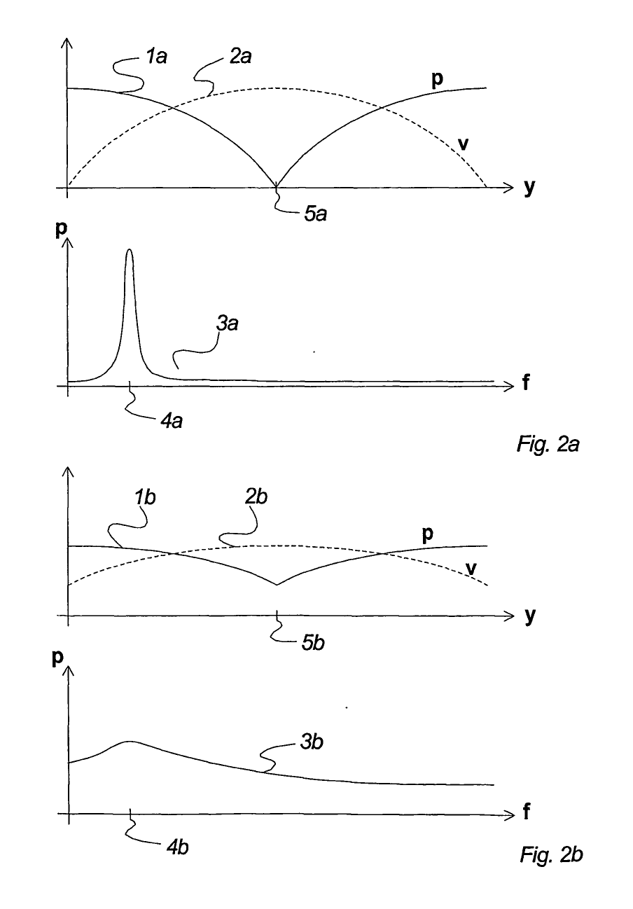

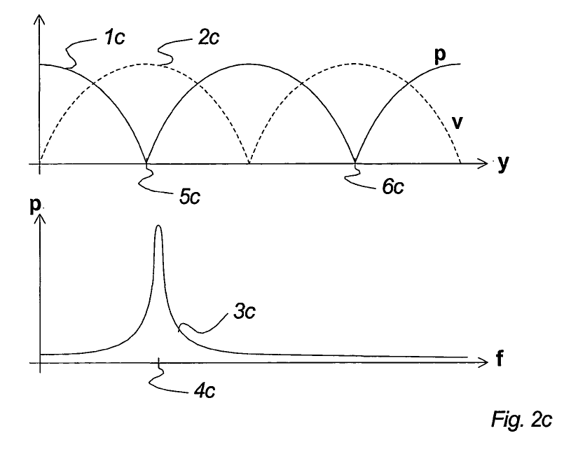

FIG. 2a shows two graphical representations of the sound in the room in FIG. 1a. The upper graph of FIG. 2a shows the sound pressure 1a and the velocity 2a as functions of the location inside of an ideal room in only the y-direction. Thus, it shows a graph of the sound pressure 1a and a graph of the particle velocity 2a. The location with the least sound pressure 5a is marked on the y-axis. Both graphs illustrate the conditions of FIG. 1a. The sound pressure is higher at the ends of the room, and only little pressure in the middle. The maximum sound pressure difference between two positions within the same room is usually as great as 30 to 40 dB if the room is small and under-damped.

The lower graph shows the frequency response 3a at a position at the end of the room, where the highest sound pressure of the resonance frequency 33 Hz is found. There is a high peak at the frequency 4a marked at the f-axis.

FIG. 2b shows the same two graphs, but for a room with better damping. Now, the sound pressure function 1b and the particle velocity function 2b are more even. There is still a pressure minimum in the middle of the room, but the difference between the pressure at the end of the room and the pressure in the middle of the room is reduced dramatically. The frequency response 3b is also much more flat than the one in FIG. 2b, while maintaining a resonance at the mark 4b. The graphs of FIG. 2b show the kind of improvements which this invention can provide to a room small and under-damped which will naturally produce sound similar to that illustrated in FIG. 2a.

FIG. 1b shows the same room as FIG. 1a, but now the mode is (0 2 0), which leads to a frequency of 66 Hz. Now, there are three locations with high sound pressure and two locations with low sound pressure inside the room. Still, the standing wave is only one-dimensional. The sound pressure, particle velocity and frequency response graphs are shown in FIG. 2c. It shows the sound pressure 1c together with the particle velocity 2c. The two locations with low sound pressure are marked 5c, 6c at the y-axis. On the lower graph, the frequency response 3c is shown with its resonance frequency 4c.

FIG. 1c shows the same room, but now the mode is (1 1 1). The frequency of the tone is calculated to 89.6 Hz. Now, only the corners of the room have high sound pressure. The standing wave is three-dimensional.

FIG. 1d again shows the same room, but with the (2 3 0) mode. The resonance frequency is 130.9 Hz. The pattern of the standing waves is beginning to be more complex. Locations with high and low pressure are scattered throughout the room. This is a two-dimensional standing wave.

As seen in FIGS. 1a-1d, the mode patterns get more complex when increasing the frequency. Also, the distance between locations with high and low pressure is reduced. This is because the half wavelength of relatively high frequencies, e.g. 1000 Hz, is reduced to several centimeters instead of meters. In short, the sound pressure gets more uniform throughout the room when increasing the frequency. And this is the reason why the invention mostly relates to sound in the low-frequency band, as this is where performance can really be improved.

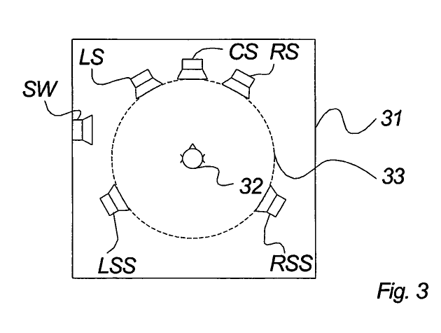

Turning now to FIG. 3, it shows a speaker set-up according to the ITU 775 multi-channel standard. It comprises a room 31 with a listening position 32. Furthermore, it comprises six speakers. Five of these are placed in a virtual circle 33 around the listening position 32. These five speakers are: a center speaker CS, a left speaker LS, a right speaker RS, a left surround speaker LSS and a right surround speaker RSS. The sixth speaker is a subwoofer SW placed arbitrarily in the room. This speaker is used only to reproduce the low-frequency band known as the bass.

Now, traditionally, when experiencing irregular bass sound pressure in a room, it is common just to equalize the subwoofer. However, when utilizing a multi-channel set-up using many speakers scattered around the room, these speakers may be used to e.g. boost the sound pressure in the locations where most efficient or to absorb the sound pressure of other locations or frequencies when too high. This is one of the functionalities of this invention.

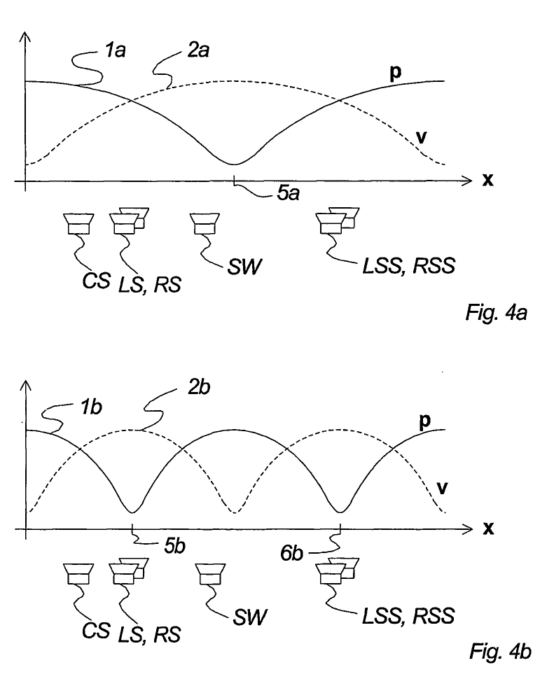

To see an example of this, please turn to FIG. 4a. This is a graph showing the same sound pressure as graph 1a and particle velocity as graph 2a as already shown in FIG. 2a. The mark 5a shows that there is only little sound pressure in the middle of the room. Below the graph, the speakers of a multi-channel set-up are shown. At the left end of the room, the center speaker CS is placed. A little to the right of the center speaker CS, the left and right speakers LS, RS are placed, and the subwoofer SW is placed almost in the middle of the room. At the right end of the room, contrary to the center speaker CS, the left and right surround speakers LSS, RSS are found. Although this sketch is very simplified with the speakers not in their exact and correct places, it is very illustrative of the principles of the invention.

When a loudspeaker plays, it does so by dissipating energy to the surrounding air. For normal loudspeakers, i.e. approximately constant velocity generators, this dissipation is most efficient when air pressure is high and the particle velocity low. When looking at FIG. 4a, it is easy to see that increasing the power of the subwoofer SW is not the most efficient way to increase the acoustical excitation of the room due to its location in the middle of the room. Instead, adding the tone to e.g. the center speaker CS, which happens to be placed near a velocity minimum, will increase the acoustical excitation of the room most efficiently. Also, the left and right speakers LS, RS and the left and right surround speakers LSS, RSS can do a much better job than the subwoofer SW in this particular set-up at this particular frequency. Of course, this requires speakers comprising the bass band to be used as the multi-channel speakers CS, LS, RS, LSS, RSS, but they do not have to be subwoofers; full-range speakers are sufficient.

Another example of a distributed subwoofer is shown in FIG. 4b. This figure is identical with FIG. 4a, except that the frequency of the tone is doubled. This means that the sound pressure graph 1b now has two minima 5b, 6b, meaning that there are two locations in the room with little sound pressure corresponding to this frequency. Contrary to the example given in FIG. 4a, the subwoofer SW is capable of great efficiency at this particular frequency. Also, the center speaker CS might be somewhat efficient for this frequency, but the left and right speakers LS, RS and the left and right surround speakers LSS, RSS are the least efficient speakers according to this set-up and frequency.

The two examples above are very simple, but other frequencies, rooms and speaker set-ups will increase the complexity. It is always possible, however, to distribute the subwoofer signal comprising the low-frequency band among the other speakers in such a way that the overall efficiency of the speakers is improved. This only requires an individual high-resolution filter for each speaker which adds a part of the subwoofer signal to the actual signal of each speaker. The part of the subwoofer signal sent to each speaker, that is the output of each high-resolution filter, can be determined by advanced algorithms based on calculation, simulation or experience. The filters depend on the actual speaker set-up and the room in which they are used. Preferably, a mix of several algorithms each designed for a specific optimization criterion is used for each filter.

The present invention uses the above-explained techniques to distribute subwoofer signals to several speakers, thereby obtaining optimized sound reproduction. It is obvious that even though the above technique is described from an ITU-775 multi-channel speaker set-up, this invention is applicable whenever there is at least one audio input signal, and at least two loudspeakers. The additional speakers improve sound optimization and efficiency obtainable.

In the following, a number of preferred embodiments of the invention and their insertion into the subwoofer signal path is described.

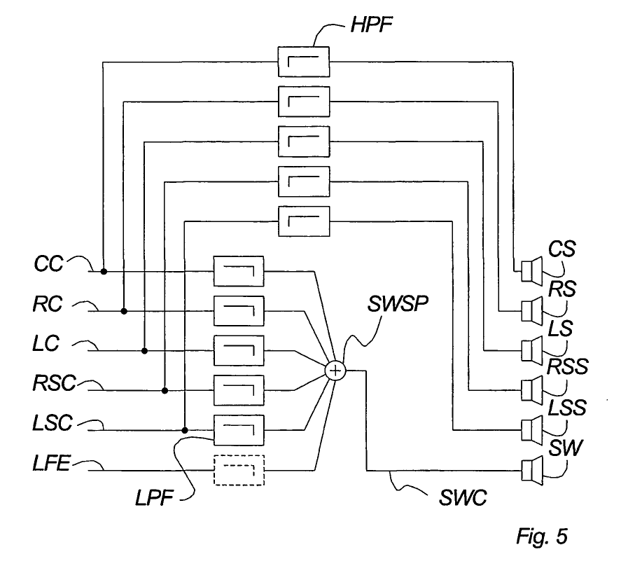

FIG. 5 illustrates how the 6 signals from a multi-channel amplifier and surround sound decoder are fed to the 6 speakers. The 6 signals are: a center channel CC, a right channel RC, a left channel LC, a right surround channel RSC, a left surround channel LSC and a special channel for low-frequency effects LFE. All channels, except for the low-frequency effects channel LFE, are fed to high-pass filters HPF and then sent to the five speakers, which are a center speaker CS, a right speaker RS, a left speaker LS, a right surround speaker RSS and a left surround speaker LSS. Each channel has its own high-pass filter and its own speaker. Further, all channels, including the low-frequency effects channel LFE, are fed to low-pass filters and then summed in a subwoofer summing point SWSP. The output from the subwoofer summing point is the subwoofer channel SWC which is used to feed the subwoofer SW. The low-frequency effects channel LFE is not necessarily run through a low-pass filter, as it is only intended for use at low frequencies.

With the embodiment of FIG. 5, which shows how a prior-art multi-channel system works, the subwoofer is the only speaker to reproduce the sound of the low-frequency band. As shown in FIGS. 1a-1d and 2a-2c, it is impossible for one subwoofer to reproduce low frequencies satisfactorily inside relatively small and under-damped rooms. And as shown in FIGS. 4a-4b, the subwoofer is very inefficient for some frequencies. Adding another subwoofer improves the performance, but distributing the subwoofer signal to all the speakers in an optimal way for the specific room and speaker setup drastically improves the bass reproduction. And this is what the present invention does, among other things.

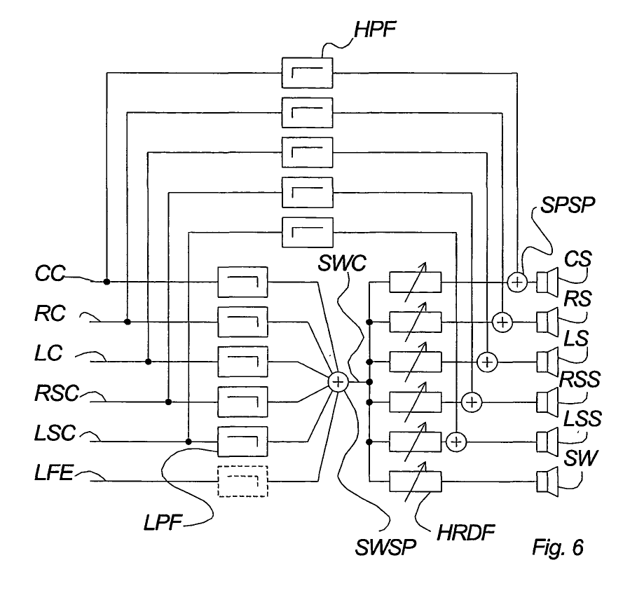

FIG. 6 shows a first preferred embodiment of the invention. The speaker set-up is still complying with the ITU-775 standard shown in FIG. 3. However, some improvements have been added to the subwoofer handling part. As with FIG. 5, the five channels: the center channel CC, right channel RC, left channel LC, right surround channel RSC and left surround channel LSC are still sent to their corresponding speakers: center speaker CS, right speaker RS, left speaker LS, right surround speaker RSS and left surround speaker LSS through high-pass filters HPF. Meanwhile, with this embodiment, some filtered signal components of the subwoofer channel SWC are sent to these speakers, too.

The signal at the subwoofer channel SWC is made in exactly the same way as in FIG. 5. That is, all channels are sent through low-pass filters LPF, and then summed together at the subwoofer summing point SWSP. But instead of sending this subwoofer channel SWC signal straight to the subwoofer SW, it is split up and sent into a high-resolution digital filter HRDF for each speaker. In this embodiment, there are 6 high-resolution digital filters because there are 6 speakers. The output signal from each high-resolution digital filter HRDF is added to the corresponding signal from the high-pass filter HPF bank in a speaker summing point SPSP and sent to the corresponding speakers CS, RS, LS, RSS and LSS. As there is no high-pass filter output signal corresponding to the subwoofer itself, this signal path has no speaker summing point SPSP.

The high-resolution digital filters HRDF are preferably FIR-filters, but any applicable filter falls within the scope of the present invention. Due to the possible small distance in frequency between the different acoustical modes of a room, it is necessary to use very narrow-banded high-precision filters. For the room shown in FIGS. 1a-1d with the dimensions 4.0×5.2×2.4, the distance between a resonance frequency and the subsequent resonance frequency is often as little as 1 Hz at frequencies about 80 Hz and higher. Thus, the precision has to be approx. 1 Hz in the low-frequency band. This requires the use of very long, FIR-filters, e.g. 1000 filter coefficient, which are rather computationally demanding filters by nature. Embodiments according to the invention only handling low-frequencies makes it possible to sample at a similarly low rate, e.g. sampling frequency=1 kHz, giving more time between samples to do the convolutions. Therefore, it is possible to implement very high-precision FIR-filters as high-resolution digital filters HRDF within the relevant frequency band. An example of such an FIR-filter could be a 1 kHz FIR-filter with 1000 taps, i.e. 1000 filter constants, resulting in an impulse response of 1 sec. duration having a frequency resolution of about 1 Hz.

This embodiment lets the five full-range speakers help the subwoofer carry out a tolerable bass reproduction by letting them act as phase-shifters, room-equalizers, active absorbers or any other kind of transfer function actuators. The improvements obtained by this invention are, among others, smoother magnitude response at the listening position, more precise bass reproduction, better efficiency, reduced distortion, improved subjective spatial properties, reduced sensivity to listening position and tolerable reproduction of bass in small under-damped rooms.

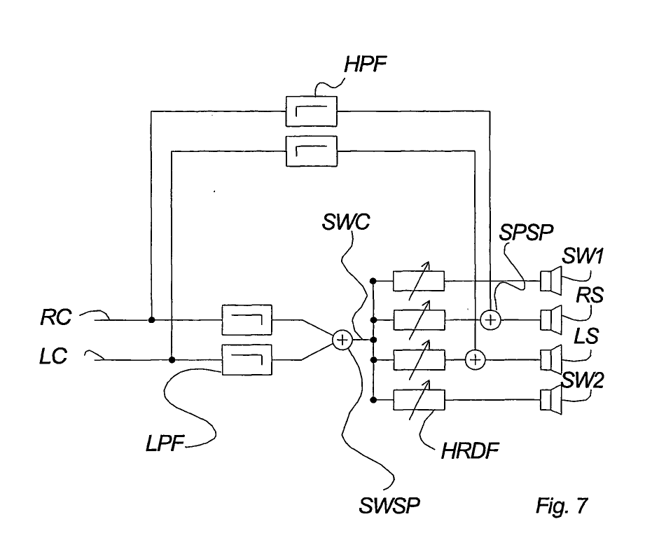

FIG. 7 illustrates another preferred embodiment of the invention. It is to be used with a common stereo loudspeaker set-up extended by two subwoofers. This embodiment comprises two audio input channels, a right channel RC and a left channel LC. These signals are led to a right speaker RS and a left speaker LS through high-pass filters HPF. Furthermore, the signals at the right and left channels RC, LC are filtered in low-pass filters LPF, and summed in a subwoofer summing point SWSP and in this way, a signal at a subwoofer channel SWC from the two channels RC, LC is produced. The signal at the subwoofer channel SWC is fed to four individual high-resolution digital filters HRDF and subsequently led a first subwoofer SW1, a second subwoofer SW2, and the right and left speakers RS, LS mentioned above. The signal played by the right speaker RS is the sum of the high-pass filtered right channel RC signal, and the high-resolution digitally filtered subwoofer channel SWC signal. The same summing procedure applies to the signal played by the left speaker LS, just as it comprises the signal from the left channel LC together with the subwoofer channel SWC signal.

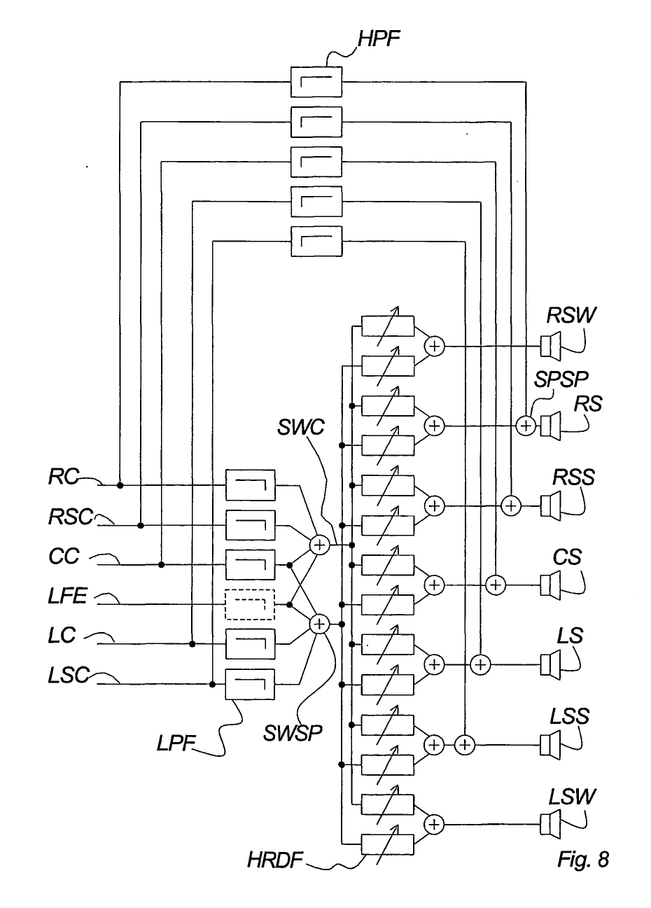

FIG. 8 illustrates a further embodiment according to ITU-775 multi-channel set-up, but now with a stereo subwoofer system.

The illustrated stereo subwoofer system implies that the multi-channel signal is mixed down to two low-frequency signals at the subwoofer summing points SWSP.

According to the invention, the two low-frequency signals may subsequently be distributed to seven loudspeakers RSW, RS, RSS, CS, KS, LSS, LSW via filtering means HRDF according to predetermined transfer functions.

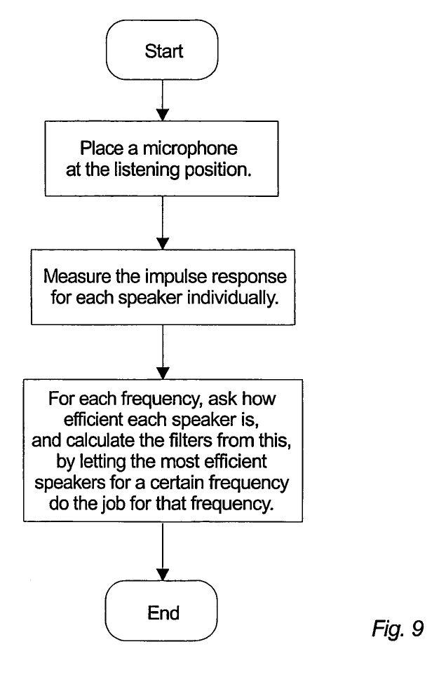

As mentioned before, the high-resolution digital filters HRDF are made by using some advanced algorithms. These algorithms can be developed from acoustics theory, from simulation, from experiments or from subjective experience. Many theories and algorithms already developed and documented in acoustic literature can be used to develop the right filters for a certain speaker set-up in a certain room. One simple example of an algorithm is shown in FIG. 9. This algorithm could be used to improve the efficiency of the bass reproduction within a room. According to the algorithm, a microphone is placed at a certain reference position, and an impulse response for each speaker is individually measured. From these impulse responses, it is possible to see which speakers are more efficient at which frequencies. From this analysis, it is possible to create the high-resolution filters HRDF to be added to the signal path of each speaker.

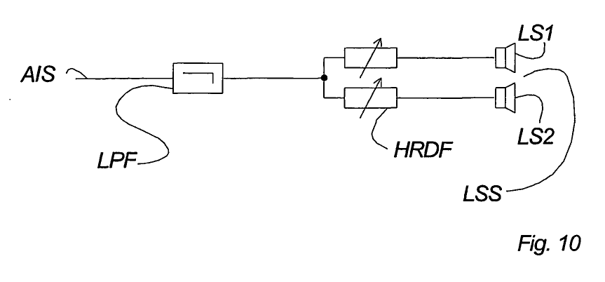

The embodiment shown in FIG. 10 illustrates subwoofer distribution according to the invention in its simplest form. It comprises an audio input signal AIS as its input, and a loudspeaker setup LSS as its output. In this simple embodiment, only one audio input signal AIS and only two loudspeakers LS1 and LS2 are shown. However, according to the invention, any number of audio input signals in excess of one may be used together with at least one loudspeaker.

The audio input signal AIS is filtered by low-pass filtering means LPF to avoid the passing of high-frequency components through to the speakers. In this way, the audio input signal AIS is turned into a subwoofer signal.

Next, the signal is distributed to high-resolution digital filters HRDF. There is one high-resolution digital filter HRDF for each loudspeaker LS. The high-resolution digital filters are individually tuned to match the exact loudspeaker setup LSS and the criterion/criteria specified by e.g. a listener.

By distributing the audio input signal AIS to more speakers LSS in this way, it is possible to obtain optimized sound reproduction, especially for low-frequency input signals when the room in which reproduction takes place is small and under-damped.

1. Method of interacting with an acoustic modal structure of a room, comprising:
determining a set of transfer functions from input of at least two loudspeakers of an arbitrary loudspeaker setup comprising the at least two loudspeakers arranged in the room, to at least one reference position;
said set of transfer functions representing an influence of the modal structure of the room when propagating audio signals from the input of said at least two loudspeakers to the at least one reference position in said room;
providing an audio input signal; and
distributing said input audio signal to the at least two loudspeakers of said loudspeaker setup as individually filtered signals, said signals being filtered on a basis of said determined at least one set of transfer functions.

2. Method of interacting with the modal structure of the room according to claim 1, wherein said individually filtered signals comprise low-frequency components below approximately 500 Hz.

3. Method of interacting with the modal structure of the room according to claim 1, wherein said individually filtered signals comprise low-frequency components below approximately 250.

4. Method of interacting with the modal structure of the room according to claim 1, wherein said transfer function is established on a basis of a measurement of sound propagation from the individual loudspeakers.

5. Method of interacting with the modal structure of the room according to claim 1 wherein said transfer function is established on a basis of theoretical sound propagation models of the sound propagation from the individual loudspeakers (LS).

6. Method of interacting with the modal structure of the room according to claim 1 wherein said loudspeaker setup comprises at least five loudspeakers.

7. Method of interacting with the modal structure of the room according to claim 1 wherein at least one of said loudspeakers of said loudspeaker setup comprises a subwoofer.

8. Method of interacting with the modal structure of the room according to claim 1 further comprising modification at given frequencies involving the loudspeakers of the loudspeaker setup situated in or relatively close to a pressure maxima of said modal structure.

9. Method of interacting with the modal structure of the room according to claim 1, further comprising:
distributing said input audio signal to the at least two loudspeakers of said loudspeaker setup as individually filtered signals, said signals being filtered on the basis of said determined at least one set of transfer functions,
wherein said individual filtering of the input signal fed to a specific loudspeaker is performed with a purpose of obtaining a flat magnitude response at said reference positions.

10. Method of interacting with the modal structure of the room according to claim 1, further comprising:
distributing said input audio signal to the at least two loudspeakers of said loudspeaker setup as individually filtered signals, said signals being filtered on the basis of said determined at least one set of transfer functions,
wherein said individual filtering of the input signal fed to a specific loudspeaker is performed with a purpose of obtaining improved efficiency.

11. Method of interacting with the modal structure of the room according to claim 1, further comprising:
distributing said input audio signal to the at least two loudspeakers of said loudspeaker setup as individually filtered signals, said signals being filtered on the basis of said determined at least one set of transfer functions,
wherein said individual filtering of the input signal fed to a specific loudspeaker is performed with the purpose of obtaining spatial properties related to interaural differences at a listener's ears when in listening position, including minimal interaural cross-correlation, “Externalization”, “Spaciousness” and/or “Envelopment”.

12. Method of interacting with the modal structure of the room according to claim 1 further comprising modification at given frequencies including deactivation or attenuation of the loudspeakers of the loudspeaker setup situated in or relatively close to a pressure minima.

13. Method of interacting with the modal structure of the room according to claim 1 wherein said individually filtered signals are established by means of long FIR-filters at a low sampling frequency.

14. Method of interacting with the modal structure of the room according to claim 1, further comprising:
distributing said input audio signal to the at least two loudspeakers of said loudspeaker setup as individually filtered signals, said signals being filtered on the basis of said determined at least one set of transfer functions,
wherein said individual filtering of the input signal fed to a specific loudspeaker is performed with a purpose of absorbing sound at certain frequencies.

15. Method of interacting with the modal structure of the room according to claim 1, further comprising:
by distributing said input audio signal to the at least two loudspeakers of said loudspeaker setup as individually filtered signals, said signals being filtered on the basis of said determined at least one set of transfer functions,
wherein said individual filtering of the input signal fed to a specific loudspeaker is performed with a purpose of adding desired room effects.

16. Method of interacting with the modal structure of the room according to claim 1, wherein said individually filtered signals distributed to said at least two loudspeakers each contribute to the interaction with said modal structure.

17. Method of interacting with the modal structure of the room according to claim 1, wherein said individually filtered signals comprise audio signals, which comprise unidirectional audio signal components when rendered in said arbitrary loudspeakers setup.

18. Method of interacting with the modal structure of the room according to claim 1, wherein
said distribution of said individually filtered signals is substantially independent of directional information of the individually filtered signals.

19. Method of interacting with the modal structure of the room according to claim 1, wherein
at least a part of said individually filtered signals is distributed to at least one channel of a rendering system intended for rendering of directional audio signals.

20. Method of interacting with the modal structure of the room according to claim 1,
wherein said reference position comprises a listening position.

21. Method of interacting with the modal structure of the room according to claim 1,
wherein said reference position comprises an arbitrarily chosen position in the room.

22. Method of interacting with the modal structure of the room according to claim 1,
wherein said individually filtered signals are established on a basis of at least one subwoofer channel of a sound rendering system.

23. Method of interacting with the modal structure of the room according to claim 1,
wherein said individually filtered signals are distributed to said loudspeakers of said loudspeaker setup on a basis of a frequency of said filtered signals.

24. Method of establishing a sound field in at least one room by means of a loudspeaker setup comprising at least two loudspeakers positioned in said room,
said method comprising:
evaluating efficiency of a rendering of at least one part of a spectrum of an input audio signal; and
rendering said at least part of the spectrum of the audio signal in at least one of said loudspeakers on a basis of the evaluated efficiency.

25. Method of establishing a sound field according to claim 24, wherein said at least one of said loudspeakers chosen for the rendering of at least one of part of the spectrum of an input audio signal comprises a loudspeaker which has a better efficiency than at least one other loudspeaker of the same loudspeaker setup when rendering the signal in the at least one room.

26. Method of establishing a sound field according to claim 24, wherein said at least a part of the spectrum of an input signal comprising low frequency signals.

27. Method of establishing a sound field according to claim 26, wherein said low frequency signal comprises low-frequency components below 500 Hz.

28. Method of establishing a sound field according to claim 24, wherein said rendering is established on a basis of at least two filter setups, and wherein said at least two filter setups are adapted to distributing said input signals to at least two different loudspeakers, said at least two filter setups being established with a purpose of distributing selected frequency bands of said input signals to selected loudspeakers.

29. Method of establishing a sound field according to claim 28, wherein said at least two frequency bands comprises at least two different modes of the modal structure of said room.

30. Method of establishing a sound field according to claim 24, wherein said loudspeaker setup comprises a multi-loudspeaker setup of at least five loudspeakers.

31. Method of establishing a sound field according to claim 24, wherein said loudspeaker setup comprises at least one subwoofer.

32. (Canceled)

33. Rendering system, comprising at least two loudspeakers arranged arbitrarily in a room; and
individual filtering means adapted to distributing an input audio signal to said at least two loudspeakers;
wherein said filtering means distributing low-frequency components of said input audio signal to said at least two loudspeakers according to at least two predetermined transfer functions,
wherein said at least two predetermined transfer functions being established on a basis of relative positioning of a modal structure of said room and said at least two loudspeakers.

34. Rendering system according to claim 33, wherein said at least two loudspeakers interact with the modal structure of the room according to claim 1.

35. System for propagating acoustic signals in a room, said system comprising
at least two loudspeakers
filtering means for distributing low-frequency components of an input audio signal to said at least two loudspeakers according to at least two predetermined transfer functions.

36. Loudspeaker controller, comprising:
at least one input means;
at least one output means;
said output means being coupled to at least two loudspeakers, preferably subwoofers; and
means for distributing at least one input signal obtained by said input means to at least two loudspeakers of a loudspeaker setup on a basis of at least one set of predetermined transfer functions;
wherein, said at least one set of transfer functions represents an influence of a modal structure of a room when propagating audio signals from the input of said at least two loudspeakers to at least one reference position in the room.

37. Subwoofer controller, comprising:
at least one input means;
at least one output means;
said output means being coupled to at least two subwoofers; and
means for distributing at least one input signal obtained by said input means to at least two subwoofers of a loudspeaker setup on a basis of at least one set of predetermined transfer functions;
wherein, said at least one set of transfer functions representatives an influence of a modal structure of a room when propagating audio signals from the input of said at least two subwoofers to at least one reference position in the room.

38. Method according to claim 1, wherein said individual filtering is performed by means of band-pass filters.

39. Method according to claim 1, wherein said individual filtering is performed by means of a band-pass filter having a bandwidth of less than 5 Hz.

40. Method according to claim 1, wherein an evaluation results in at least one specific transfer function relating to the at least two loudspeakers of the loudspeaker setup, said transfer function(s) determining the resulting transfer function of input audio signals from the individual loudspeakers at a given position or given positions in the room in relation to the at least one reference position in the room.

41. Method according to claim 24, wherein said individual filtering is performed by means of band-pass filters.

42. Method according to claim 24, wherein said individual filtering is performed by means of a band-pass filter having a bandwidth of less than 5 Hz.

43. Method according to claim 24, wherein an evaluation results in at least one specific transfer function relating to the at least two loudspeakers of the loudspeaker setup said transfer function(s) determining the resulting transfer function of input audio signals from the individual loudspeakers at a given position or given positions in the room in relation to at least one reference position in the room.

44. Method according to claim 38, wherein an evaluation results in at least one specific transfer function relating to the at least two loudspeakers of the loudspeaker setup said transfer function(s) determining the resulting transfer function of input audio signals from the individual loudspeakers at a given position or given positions in the room in relation to at least one reference position in the room.

45. Method according to claim 39, wherein an evaluation results in at least one specific transfer function relating to the at least two loudspeakers of the loudspeaker setup said transfer function(s) determining the resulting transfer function of input audio signals from the individual loudspeakers at a given position or given positions in the room in relation to at least one reference position in the room.

46. Rendering system according to claim 33, wherein said at least two loudspeakers interact with the modal structure of the room according to claim 24.
